(19) United States
(12) Patent Application Publication
(10) Pub. No.: US 2013/0117302 A1
(43) Pub. Date: May 9, 2013

(54) APPARATUS AND METHOD FOR SEARCHING FOR INDEX-STRUCTURED DATA INCLUDING MEMORY-BASED SUMMARY VECTOR

(71) Applicant: Electronics and Telecommunications Research In, Daejeon (KR)

(72) Inventors: Joongsoo Lee, Daejeon (KR); Hag Young Kim, Daejeon (KR); Chang Soo Kim, Daejeon (KR); Yong-Ju Lee, Daejeon (KR); Jin-Hwan Jeong, Seoul (KR); Choon Seo Park, Daejeon (KR); Jung-Hyun Cho, Daejeon (KR)

(73) Assignee: Electronics and Telecommunications Research Institute, Daejeon (KR)

(21) Appl. No.: 13/667,535

(22) Filed: Nov. 2, 2012

(30) Foreign Application Priority Data
Nov. 3, 2011 (KR) 10-2011-0114183

(51) Int. Cl. G06F 17/30

(52) U.S. Cl. 707/769; 707/E17.002; 707/E17.014

(57) ABSTRACT

An apparatus and method for searching for index-structured data including a memory-based summary vector are disclosed. The apparatus for searching for index-structured data including a memory-based summary vector includes a storage unit configured to store a full index and data related to a key; and a key lookup engine configured to include not only a summary vector but also an index storing information related to the full index, search for data stored in the storage unit through the index, and return the searched result.

### CROSS-REFERENCE TO RELATED APPLICATIONS

The present application claims priority to Korean patent application number 10-2011-0114183, filed on Nov. 3, 2011, which is incorporated by reference in its entirety.

### BACKGROUND OF THE INVENTION

The present invention relates to an apparatus and method for searching for data, and more particularly to an apparatus and method for searching for index-structured data including a memory-based summary vector that is capable of supporting a high-speed lookup operation in an index structure configured to manage a fixed key and a value mapped to the fixed key.

Functions of storing and searching for data very frequently occur in computer software such that the functions are requisite for the computer software.

In this case, indexes are used for efficient searching. Provided that numerous memories are needed for constructing such indexes, it is difficult for all indexes to be loaded on the memory.

Therefore, a summary vector is used to predict the presence or absence of data without searching for data through indexes, and full index indicating all indexes is divided into a memory and a disc and stored therein.

The summary vector provides a function capable of predicting whether data to be desired is stored or not, such that it can reduce an access time of a disc operating at a low speed, resulting in the improvement of software performance.

Typically, bloom filters have generally been used to implement a summary vector.

The related art of the present invention has been disclosed in United States Patent Publication No. 20100257315 (published on Oct. 7, 2010).

As described above, bloom filters have generally been used to implement the summary vector. Specifically, the bloom filters have been designed to use different hash functions.

However, if the hash function is applied to the bloom filter, the number of calculations of Central Processing Unit (CPU) is unavoidably increased, such that it is difficult for the bloom filter implemented with the hash function to be applied to a background operating service such as a file system.

In addition, since the bloom filter is used in the conventional apparatus, some indexes need to be maintained in a separate memory, so that the conventional apparatus is quite ineffective in terms of a memory usage.

### SUMMARY OF THE INVENTION

Various embodiments of the present invention are directed to an apparatus and method for searching for index-structured data including a memory-based summary vector that substantially obviate one or more problems due to limitations or disadvantages of the related art.

Embodiments of the present invention are directed to a data lookup apparatus of an index structure including a memory-based summary vector, which implement a summary vector structure using a difference between data segments stored in a memory without using a hash function, and connect the summary vector structure to an index so as to construct a summary vector integrated with indexing, thereby efficiently utilizing a CPU and a memory.

In accordance with an embodiment, an apparatus for searching for index-structured data including a memory-based summary vector includes a storage unit configured to store a full index and data related to a key; and a key lookup engine configured to include not only a summary vector but also an index storing information related to the full index, search for data stored in the storage unit through the index, and return the searched result.

The index may be divided into a plurality of key part indexes and indexed, and a plurality of equal-sized partial keys may be sequentially stored in the key part indexes.

Each of the key part indexes may be divided into a plurality of super-blocks according to a prefix, and indexed.

The super-block may include a plurality of super-block entries, and the super-block entries are respectively mapped to key blocks of the storage unit.

The super-block entries may be sequentially filled with data according to the order of key storing.

The super-block entry may include a summary of the key block and a location of the key block.

The summary may be generated by performing a modular operation on the partial key with the number of bits of a summary vector, and if the partial key is added, a bit indicated by the modular operation result is set to 1.

The summary vector may have a predetermined magnitude larger than the number of the partial keys stored in the key block.

In accordance with another embodiment, a method for searching for index-structured data including a memory-based summary vector includes upon receiving a request for searching for a key, dividing the key into a plurality of partial keys; determining whether the divided partial keys are present in a summary of all key part indexes contained in an index; if the divided partial keys are present in the summary of all the key part indexes, reading key locations from all key blocks corresponding to the summary; determining whether the key locations read from all the key blocks are identical; and if the key locations read from all the key blocks are identical, reading a value corresponding to the key at each key location.

The determining whether the divided partial keys are present in the summary of all the key part indexes contained in the index may include determining whether a bit corresponding to the partial key is set to a value of 1 in the summary of the partial key index.

The determining whether the key locations read from all the key blocks are identical may include determining whether the key locations indicated by all the partial keys are different from each other.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a block diagram illustrating an apparatus for searching for index-structured data including a memory-based summary vector according to an embodiment of the present invention.

FIG. 2 shows an index structure of a key lookup engine unit shown in FIG. 1 according to an embodiment of the present invention.

FIG. 3 is a conceptual diagram illustrating a method for dividing one key shown in FIG. 2 into a plurality of partial keys according to an embodiment of the present invention.

FIG. 4 shows the relationship between a super-block shown in FIG. 1 and a key block of a storage unit according to an embodiment of the present invention.

FIG. 5 is a flowchart illustrating a method for searching for index-structured data including a memory-based summary vector according to an embodiment of the present invention.

### DESCRIPTION OF SPECIFIC EMBODIMENTS

Reference will now be made in detail to the embodiments of the present invention, examples of which are illustrated in the accompanying drawings. Wherever possible, the same reference numbers will be used throughout the drawings to refer to the same or like parts. An apparatus and method for searching for index-structured data including a memory-based summary vector according to the present invention will be described in detail with reference to the accompanying drawings. In the drawings, line thicknesses or sizes of elements may be exaggerated for clarity and convenience. Also, the following terms are defined considering functions of the present invention, and may be differently defined according to intention of an operator or custom. Therefore, the terms should be defined based on overall contents of the specification.

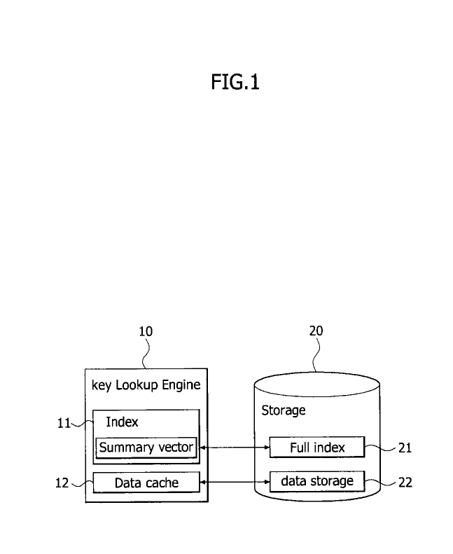

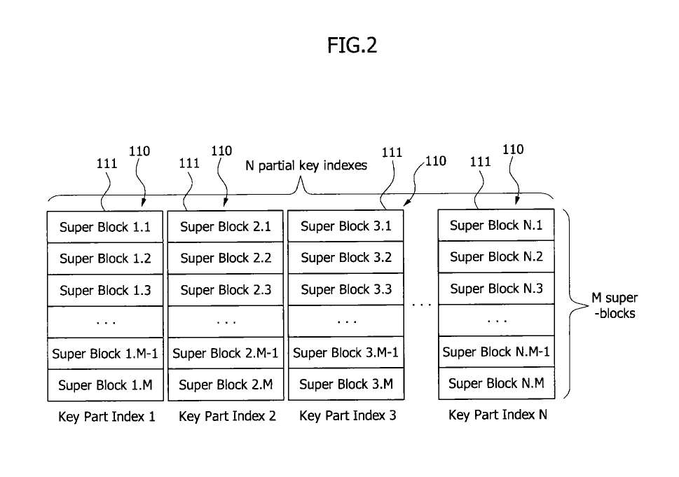

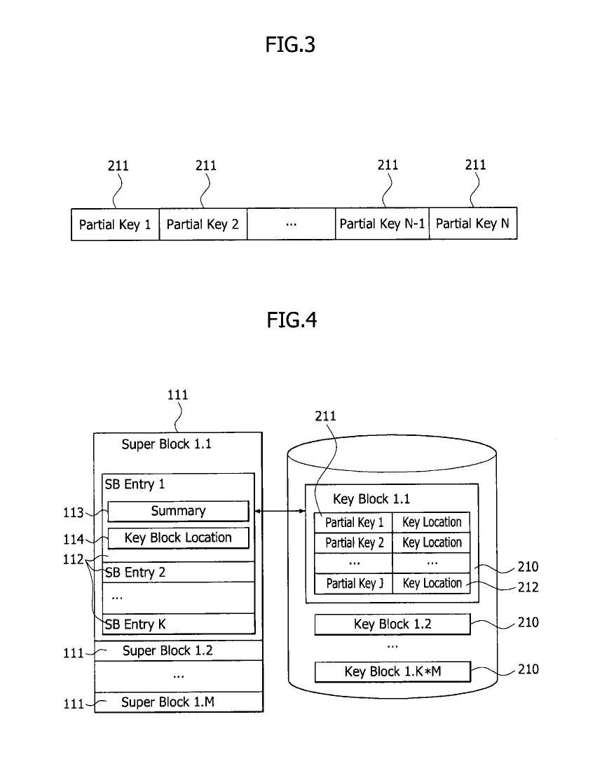

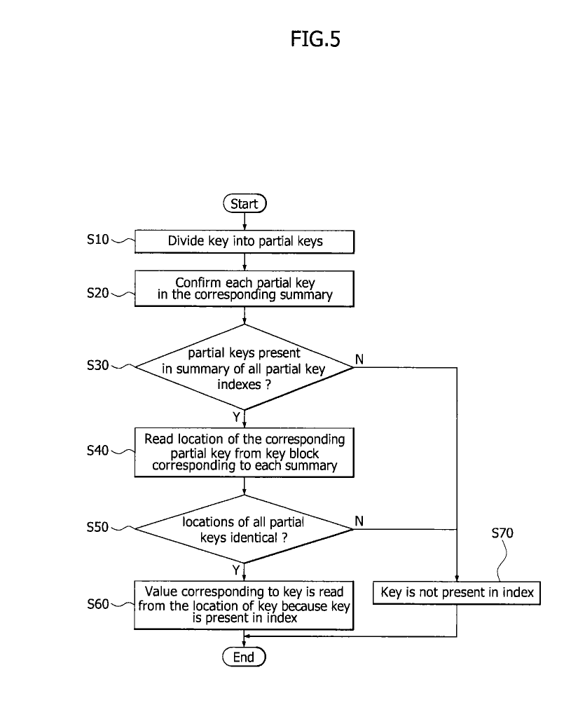

FIG. 1 is a block diagram illustrating an apparatus for searching for index-structured data including a memory-based summary vector according to an embodiment of the present invention. FIG. 2 shows an index structure of a key lookup engine unit shown in FIG. 1 according to an embodiment of the present invention. FIG. 3 is a conceptual diagram illustrating a method for dividing one key shown in FIG. 2 into a plurality of partial keys according to an embodiment of the present invention. FIG. 4 shows the relationship between a super-block shown in FIG. 1 and a key block of a storage unit according to an embodiment of the present invention.

Generally, data searching (or data lookup) is a method for recognizing a specific value that is one-to-one mapped to a key.

The embodiment of the present invention provides indexing for data searching and a summary vector. More specifically, the embodiment provides a method for mapping a value of a fixed-sized key.

Typically, a fixed-sized key can be found in data searching, and a representative example of the fixed-sized key is a hash function. For example, SHA1, SHA256, MD5, etc. are exemplary functions capable of returning a fixed-sized hash value in response to an input data value, and the exemplary functions are used as a key for searching data including many hash values.

For reference, the above-mentioned embodiment has been disclosed on the basis of an application example of a deduplication-based file system. A chunk corresponding to some parts of the file is hashed, the resultant hash values are stored in an index 11 and a summary 113, and the stored hash values are used to reach an actual chunk.

The apparatus for searching for index-structured data including a memory-based summary vector according to an embodiment of the present invention includes a key lookup engine 10 and a storage unit 20 as shown in FIG. 1.

The storage unit 20 includes a full index for searching for data and a data storage unit 22 for storing data.

The key lookup engine 10 can search for data related to a key or can detect the presence or absence of such key-related data. The key lookup engine 10 searches not only data stored in a full index 21 stored in the storage unit 20 but also data stored in the data storage unit 22, and returns the search result. The key lookup engine 10 includes an index 11 and a data cache 12.

The data cache 12 stores frequently-used data in a memory, such that it can reduce the frequency of accessing the storage unit 20 operating at a relatively low speed.

For reference, the data cache 12 is a general functional module for searching for data, and as such a detailed description thereof will herein be omitted for convenience of description.

The index 11 includes a summary vector, and stores a variety of information related to the full index 21.

A structure of the index 11 is shown in FIG. 2.

One key is divided into a plurality of parts and the divided parts are indexed with different numbers. In other words, the index 11 can be indexed with N key part indexes 110.

Respective key part indexes 110 are divided into a plurality of super blocks according to a prefix and the super-blocks are then indexed with different numbers.

Referring to FIG. 2, a total of N key part indexes 110 are provided, and each key part index 110 includes M super-blocks 111, such that (M×N) super-blocks 111 can be configured.

For example, assuming that a key composed of 160 bits is indexed with 10 key part indexes 110, one key part index 110 provides a summary 113 for a partial key 211 corresponding to 16 bits.

In addition, assuming that one key part index 110 includes 256 super-blocks 111, the first 8 bits from among 16 bits are stored in the same-key summary 113 within one super-block 111.

As described above, one key is divided into a plurality of parts. As shown in FIG. 3, one key can be divided into a plurality of partial keys 211.

In this case, the partial key 211 is divided into a plurality of equal-sized parts and then generated. The partial keys 211 are sequentially stored in the key part index 110. A super block 111 to be stored is selected from the key part index 110 on the basis of some initial bits of the partial key 211.

As can be seen from FIG. 4, the super block 111 includes K super-block (SB) entries 112.

The relationship between one super-block 111 and a key block 210 of a storage unit 20 mapped to the one super-block 111 will hereinafter be described with reference to FIG. 4.

The super-block 111 includes K SB entries 112, and each SB entry includes a summary 113 and a key block location 114.

The SB entries 112 are sequentially filled with data in order of key storing. In other words, a first SB entry is first filled with data and the last SN entry is finally filled with data according to the order of key storing. Referring to FIG. 4, if the number of stored keys exceeds a predetermined number of keys capable of being stored in the first SB entry 112, the exceeding keys are stored in the next SB entry 112.

The SB entries 112 are mapped to the key block 210, and the summary 113 contained in the SB entry 112 corresponds to a summary 113 for one key block 210.

The summary 113 is generated by performing a modular operation on the partial key 211 with the number of bits of a summary vector. In this case, if a new partial key 211 is added, a bit indicated by the modular operation result is set to 1.

The magnitude of the summary vector is determined according to the number of summary vectors stored in the key block 210. If the number of bits of the summary 113 is identical to the number of key blocks 210, a large number of cases corresponding to the same bit in the modular operation may occur, such that the magnitude of a summary vector is determined to be larger than the number of partial keys 211 stored in the key block 210.

Meanwhile, the key block 210 is stored in the storage unit 20, and includes the relationship between the partial key 211 and the location of an original key. The key block 210 is created one by one whenever the SB entry 112 is added. M super-blocks (SBs) are present in one key part index 110, such that a total of (K×M) key blocks 210 are stored in the storage unit 20.

A method for searching for index-structured data including a memory-based summary vector according to the present invention will hereinafter be described with reference to FIG. 5.

FIG. 5 is a flowchart illustrating a method for searching for index-structured data including a memory-based summary vector according to an embodiment of the present invention.

Referring to FIG. 5, the key lookup engine 10 determines the presence or absence of a request for searching for one key.

In this case, if the request for searching for one key is generated by a user, this key is divided into a plurality of partial keys 211 (Step S10).

As described above, if the key requested by a user is divided into a plurality of partial keys 211, each partial key 211 is confirmed at the corresponding summary 113 of each key part index 110 (Step S20).

Thereafter, it is determined whether the partial key 211 is present in the summary 113 of all key part indexes 110 (Step S30).

If it is determined that the partial key 211 is not present in the summary 113 of all key part indexes 110, that is, if a bit corresponding to the partial key 211 is not set to ‘1’ in the summary 113 of the key part index 110, this means that the key is not present in the index 11, such that the corresponding key is determined to be a new key not contained in the index (Step S70).

On the other hand, if a bit corresponding to the corresponding partial key 211 is set to ‘1’ in the summary 113 of all key part indexes 110, there is a high possibility that the corresponding key is prestored in the index 11, such that the location of a key can be read from all the key blocks 210 corresponding to the summary 113 (Step S40).

Thereafter, it is determined whether the locations of all partial keys 211 are identical. In more detail, this determination can be achieved by determining the presence of the partial key 211 indicating that data was stored at the same location in all the key part indexes 110 (Step S50).

As described above, if the locations of all the partial keys 211 are identical, this means that the key is present in the index 11, such that a value corresponding to the corresponding key can be read at the corresponding key location 212 (Step S60).

In contrast, if the bit corresponding to the partial key 211 is set to ‘1’ and the key locations indicated by all the partial keys 211 are different from one another, the corresponding key is determined to be a new key not present in the index 11 (Step S70).

As is apparent from the above description, the apparatus and method for searching for index-structured data according to the present invention can simultaneously use a summary vector and an index so as to reduce a memory space, and need not use a hash function so as to calculate the summary vector, resulting in reduction in the number of CPU calculations.

While the present invention has been described with respect to the specific embodiments, it will be apparent to those skilled in the art that various changes and modifications may be made without departing from the spirit and scope of the invention as defined in the following claims.

What is claimed is:

1. An apparatus for searching for index-structured data including a memory-based summary vector, comprising:
a storage unit configured to store a full index and data related to a key; and
a key lookup engine configured to include a summary vector and an index storing information related to the full index, to search for data stored in the storage unit through the index, and to return the searched result.

2. The apparatus according to claim 1, wherein the index is divided into a plurality of key part indexes and indexed, and a plurality of equal-sized partial keys are sequentially stored in the key part indexes.

3. The apparatus according to claim 2, wherein each of the key part indexes is divided into a plurality of super-blocks according to a prefix, and indexed.

4. The apparatus according to claim 3, wherein the super-block includes a plurality of super-block entries, and the super-block entries are respectively mapped to key blocks of the storage unit.

5. The apparatus according to claim 4, wherein the super-block entries are sequentially filled with data according to the order of key storing.

6. The apparatus according to claim 4, wherein the super-block entry includes a summary of the key block and a location of the key block.

7. The apparatus according to claim 6, wherein the summary is generated by performing a modular operation on the partial key with the number of bits of a summary vector, and if the partial key is added, a bit indicated by the modular operation result is set to 1.

8. The apparatus according to claim 7, wherein the summary vector has a predetermined magnitude larger than the number of the partial keys stored in the key block.

9. A method for searching for index-structured data including a memory-based summary vector comprising:
upon receiving a request for searching for a key, dividing the key into a plurality of partial keys;
determining whether the divided partial keys are present in a summary of all key part indexes contained in an index;
if the divided partial keys are present in the summary of all the key part indexes, reading key locations from all key blocks corresponding to the summary;
determining whether the key locations read from all the key blocks are identical; and
if the key locations read from all the key blocks are identical, reading a value corresponding to the key at each key location.

10. The method according to claim 9, wherein the determining whether the divided partial keys are present in the summary of all the key part indexes contained in the index includes determining whether a bit corresponding to the partial key is set to a value of 1 in the summary of the partial key index.

11. The method according to claim 9, wherein the determining whether the key locations read from all the key blocks are identical includes determining whether the key locations indicated by all the partial keys are different from each other.
